(19) United States
(12) Patent Application Publication
(10) Pub. No.: US 2022/0176992 A1
(43) Pub. Date: Jun. 9, 2022

(54) VEHICLE CONTROL SYSTEM, AUTONOMOUS DRIVING VEHICLE, AND VEHICLE CONTROL METHOD

(71) Applicant: TOYOTA JIDOSHA KABUSHIKI KAISHA, Toyota-shi Aichi-ken (JP)

(72) Inventors: Kazuki Nemoto, Susono-shi Shizuoka-ken (JP); Shin Tanaka, Numazu-shi Shizuoka-ken (JP); Satoshi Nakamura, Susono-shi Shizuoka-ken (JP)

(73) Assignee: TOYOTA JIDOSHA KABUSHIKI KAISHA, Toyota-shi Aichi-ken (JP)

(21) Appl. No.: 17/511,974

(22) Filed: Oct. 27, 2021

(30) Foreign Application Priority Data
Dec. 9, 2020 (JP) 2020-204392

(51) Int. Cl. B60W 60/00; B60W 50/02; B60W 50/035

(52) U.S. Cl. CPC B60W 60/007; B60W 60/0015; B60W 50/035; B60W 50/0205

(57) ABSTRACT

A vehicle control system predicts danger to be avoided by a vehicle based on information related to a surrounding environment of the vehicle. When the danger is predicted, the vehicle control system determines whether an autonomous driving system rejects intervention in autonomous driving, and performs a diagnosis as to whether the autonomous driving system is normal or abnormal. Further, the vehicle control system performs the intervention in the autonomous driving to avoid the predicted danger when the autonomous driving system does not reject the intervention in the autonomous driving or when the autonomous driving system is abnormal even when the autonomous driving system rejects the intervention in the autonomous driving. However, the vehicle control system stops the intervention in the autonomous driving when the autonomous driving system rejects the intervention in the autonomous driving in a state where the autonomous driving system is normal.

### CROSS-REFERENCE TO RELATED APPLICATION

This application claims priority to Japanese Patent Application No. 2020-204392 filed on Dec. 9, 2020, incorporated herein by reference in its entirety.

### BACKGROUND

### 1. Technical Field

The present disclosure relates to a vehicle control system, an autonomous driving vehicle, and a vehicle control method.

### 2. Description of Related Art

Japanese Unexamined Patent Application Publication No. 2016-203882 (JP 2016-203882 A) discloses a related art in which a travel plan creation unit creates a vehicle travel plan based on a target route and surrounding information, and a travel controller causes a vehicle to autonomously travel based on travel plan. The travel plan creation unit generates a target trajectory that is a trajectory on which the vehicle travels on the target route, as the travel plan. In this case, the travel plan creation unit generates the target trajectory of the vehicle to avoid contact with an obstacle based on the status of the obstacle in the periphery of the vehicle.

### SUMMARY

In the related art described above, the target trajectory is generated in consideration of the presence of the obstacle. However, for example, it is difficult to handle unexpected sudden motion of the obstacle, such as sudden stop of a preceding vehicle or running out of a person in front of the vehicle, or danger caused by the appearance of the sudden obstacle, by generating the target trajectory. As a technique for avoiding a collision with the obstacle, a preventive safety function for avoiding danger by intervention in a travel control of the vehicle is known. Pre-crash safety (PCS) is one example thereof. With the PCS, in a case where the obstacle having a possibility of causing the collision is detected, the collision with the obstacle is avoided by decelerating or stopping the vehicle by an autonomous brake control. In a case where the PCS is applied to the related art, the autonomous driving is usually performed based on the target trajectory, and in a case where the obstacle with a possibility of causing the collision is detected, the intervention by the PCS in the autonomous driving is performed.

However, when the intervention by the preventive safety function, such as the PCS, in the autonomous driving is performed, an operation of the vehicle is different from an operation requested to realize the target trajectory. Therefore, although the danger is requested to be surely avoided, it is desirable to suppress the preventive safety function from not needed intervention in the autonomous driving in a situation in which the realization of the target trajectory is requested.

The present disclosure has been made in view of the problems described above, and is to provide a vehicle control technique capable of surely avoiding danger and suppressing not needed intervention in the autonomous driving in a situation in which the realization of a target trajectory is requested.

First, a vehicle control system according to a first aspect of the present disclosure will be described. The vehicle control system according to the first aspect of the present disclosure is a system that is mounted on a vehicle that performs autonomous driving, predicts danger based on information related to a surrounding environment of the vehicle, and performs intervention in the autonomous driving to avoid the predicted danger. The vehicle control system according to the first aspect of the present disclosure includes at least one memory including at least one program, and at least one processor coupled to the at least one memory. The at least one processor executes the following operations by execution of at least one program. A first operation is performing communication with an autonomous driving system. The autonomous driving system is a system that generates a target trajectory of the vehicle and causes the vehicle to travel by the autonomous driving to follow the target trajectory. A second operation is receiving an override signal for rejecting the intervention in the autonomous driving from the autonomous driving system. A third operation is performing a diagnosis as to whether the autonomous driving system is normal or abnormal. Further, a fourth operation is stopping the intervention in the autonomous driving solely in a case where the override signal is received and the autonomous driving system is normal.

With the vehicle control system having the above characteristics, in a case where the autonomous driving system is normal, the vehicle control system receives the override signal transmitted from the autonomous driving system and stops the intervention in the autonomous driving. As a result, the not needed intervention in the autonomous driving in a situation in which the realization of the target trajectory is requested is suppressed. On the other hand, in a case where the autonomous driving system is abnormal, the vehicle control system does not stop the intervention in the autonomous driving even when the override signal is received from the autonomous driving system. As a result, the danger can be surely avoided.

In the vehicle control system according to the first aspect of the present disclosure, the at least one processor may be configured to receive a result of a self-diagnosis from the autonomous driving system and perform the diagnosis as to whether the autonomous driving system is normal or abnormal based on the result of the self-diagnosis. Accordingly, when the result of the self-diagnosis declared by the autonomous driving system is normal, the diagnosis can be made that the autonomous driving system is normal, and when the result of the self-diagnosis declared is abnormal, the diagnosis can be made that the autonomous driving system is abnormal.

In the vehicle control system according to the first aspect of the present disclosure, the at least one processor may be configured to receive a survival confirmation signal periodically transmitted from the autonomous driving system and perform the diagnosis as to whether the autonomous driving system is normal or abnormal based on the survival confirmation signal. Accordingly, while the survival confirmation signal is periodically transmitted from the autonomous driving system, the diagnosis can be made that the autonomous driving system is normal, and in a case where the survival confirmation signal is interrupted, the diagnosis can be made that the autonomous driving system is abnormal.

In the vehicle control system according to the first aspect of the present disclosure, the at least one processor may be configured to irregularly or regularly perform a call with respect to the autonomous driving system and perform the diagnosis as to whether the autonomous driving system is normal or abnormal based on a response from the autonomous driving system to the call. Accordingly, while the autonomous driving system responds to the call from the vehicle control system, the diagnosis can be made that the autonomous driving system is normal, and in a case where the autonomous driving system does not respond to the call, the diagnosis can be made that the autonomous driving system is abnormal.

In the vehicle control system according to the first aspect of the present disclosure, the at least one processor may be configured to perform evaluation for the autonomous driving performed by the autonomous driving system and perform the diagnosis as to whether the autonomous driving system is normal or abnormal based on a result of the evaluation. Since whether the autonomous driving system is normal or abnormal appears in a result of the autonomous driving, the diagnosis can be made as to whether the autonomous driving system is normal or abnormal by performing the evaluation for the autonomous driving.

Next, an autonomous driving vehicle according to a second aspect of the present disclosure will be described. The autonomous driving vehicle according to the second aspect of the present disclosure includes an autonomous driving system that generates a target trajectory and performs autonomous driving to follow the target trajectory, and a vehicle control system that predicts danger based on information related to a surrounding environment and performs intervention in the autonomous driving to avoid the predicted danger. The autonomous driving system transmits an override signal for rejecting the intervention in the autonomous driving to the vehicle control system in a case where the intervention in the autonomous driving by the vehicle control system is not needed. The vehicle control system receives the override signal from the autonomous driving system and performs a diagnosis as to whether the autonomous driving system is normal or abnormal. Further, the vehicle control system stops the intervention in the autonomous driving solely in a case where the override signal from the autonomous driving system is received and the autonomous driving system is normal.

With the autonomous driving vehicle having the above characteristics, in a case where the autonomous driving system is normal, the vehicle control system receives the override signal transmitted from the autonomous driving system and stops the intervention in the autonomous driving. As a result, the not needed intervention in the autonomous driving by the vehicle control system in a situation in which the realization of the target trajectory is requested is suppressed. On the other hand, in a case where the autonomous driving system is abnormal, the vehicle control system does not stop the intervention in the autonomous driving even when the override signal is received from the autonomous driving system. As a result, the danger can be surely avoided by the vehicle control system.

In the autonomous driving vehicle according to the second aspect of the present disclosure, the autonomous driving system may transmit the override signal to the vehicle control system in a case where the intervention in the autonomous driving by the vehicle control system is estimated and the estimated intervention in the autonomous driving is not needed. Accordingly, in a case where the autonomous driving system is normal, before the estimated intervention in the autonomous driving by the vehicle control system is performed, the override signal can be transmitted to the vehicle control system and the intervention in the autonomous driving can be stopped.

In the autonomous driving vehicle according to the second aspect of the present disclosure, the vehicle control system may previously notify the autonomous driving system of the intervention in the autonomous driving in a case where the vehicle control system performs the intervention in the autonomous driving, and the autonomous driving system may transmit the override signal to the vehicle control system in a case where the previously notified intervention in the autonomous driving is not needed. Accordingly, in a case where the autonomous driving system is normal, before the intervention in the autonomous driving previously notified by the vehicle control system is performed, the override signal can be transmitted to the vehicle control system and the intervention in the autonomous driving can be stopped.

In the autonomous driving vehicle according to the second aspect of the present disclosure, the autonomous driving system may perform a self-diagnosis as to whether the autonomous driving system itself is normal or abnormal and transmits a result of the self-diagnosis to the vehicle control system. Further, the vehicle control system may receive the result of the self-diagnosis from the autonomous driving system and may perform the diagnosis as to whether the autonomous driving system is normal or abnormal based on the result of the self-diagnosis. Accordingly, when the result of the self-diagnosis declared by the autonomous driving system is normal, the diagnosis can be made that the autonomous driving system is normal, and when the result of the self-diagnosis declared is abnormal, the diagnosis can be made that the autonomous driving system is abnormal.

In the autonomous driving vehicle according to the second aspect of the present disclosure, the autonomous driving system may periodically transmit a survival confirmation signal to the vehicle control system. Further, the vehicle control system may receive the survival confirmation signal from the autonomous driving system and may perform the diagnosis as to whether the autonomous driving system is normal or abnormal based on the survival confirmation signal. Accordingly, while the survival confirmation signal is periodically transmitted from the autonomous driving system, the diagnosis can be made that the autonomous driving system is normal, and in a case where the survival confirmation signal is interrupted, the diagnosis can be made that the autonomous driving system is abnormal.

In the autonomous driving vehicle according to the second aspect of the present disclosure, the autonomous driving system may respond to an irregular or regular call from the vehicle control system. Further, the vehicle control system may perform the diagnosis as to whether the autonomous driving system is normal or abnormal based on the response from the autonomous driving system. Accordingly, while the autonomous driving system responds to the call from the vehicle control system, the diagnosis can be made that the autonomous driving system is normal, and in a case where the autonomous driving system does not respond to the call, the diagnosis can be made that the autonomous driving system is abnormal.

In the autonomous driving vehicle according to the second aspect of the present disclosure, the vehicle control system may perform evaluation for the autonomous driving performed by the autonomous driving system and may perform the diagnosis as to whether the autonomous driving system is normal or abnormal based on a result of the evaluation. Since whether the autonomous driving system is normal or abnormal appears in the result of the autonomous driving, the diagnosis can be made as to whether the autonomous driving system is normal or abnormal by performing the evaluation for the autonomous driving.

Next, a vehicle control method according to a third aspect of the present disclosure will be described. The vehicle control method according to the third aspect of the present disclosure is a method of controlling a vehicle that is autonomously driven to follow a target trajectory by an autonomous driving system. With the vehicle control method according to the third aspect of the present disclosure, danger to be avoided by the vehicle is predicted based on information related to a surrounding environment of the vehicle. With the vehicle control method according to the third aspect of the present disclosure, in a case where the danger to be avoided by the vehicle is predicted, a determination is made as to whether or not the autonomous driving system rejects intervention in the autonomous driving, and a diagnosis is made as to whether the autonomous driving system is normal or abnormal. With the vehicle control method according to the third aspect of the present disclosure, the intervention in the autonomous driving is performed to avoid the predicted danger in a case where the autonomous driving system is abnormal or the autonomous driving system does not reject the intervention in the autonomous driving. However, with the vehicle control method according to the third aspect of the present disclosure, the intervention in the autonomous driving is stopped in a case where the autonomous driving system rejects the intervention in the autonomous driving in a state where the autonomous driving system is normal.

With the vehicle control method having the above characteristics, in a case where the autonomous driving system is normal, the intervention in the autonomous driving is stopped when the autonomous driving system rejects the intervention. As a result, the not needed intervention in the autonomous driving in a situation in which the realization of the target trajectory is requested is suppressed. On the other hand, in a case where the autonomous driving system is abnormal, the intervention in the autonomous driving is performed even when the autonomous driving system rejects the intervention. As a result, the danger can be surely avoided.

In the vehicle control method according to the third aspect of the present disclosure, the diagnosis as to whether the autonomous driving system is normal or abnormal may be performed based on at least one of the following.
a: a result of a self-diagnosis by the autonomous driving system
b: a survival confirmation signal periodically transmitted from the autonomous driving system
c: a response from the autonomous driving system to a call in a case where the call is irregularly or regularly performed with respect to the autonomous driving system
d: a result of evaluation for the autonomous driving performed by the autonomous driving system

According to the present disclosure, in a case where the autonomous driving system is normal, the intervention in the autonomous driving is stopped when the autonomous driving system rejects the intervention, and in a case where the autonomous driving system is abnormal, the intervention in the autonomous driving is performed even when the autonomous driving system rejects the intervention. As a result, the danger to be avoided can be surely avoided and the not needed intervention in the autonomous driving in a situation in which the realization of the target trajectory is requested can be suppressed.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram describing an override of a preventive safety function by an autonomous driving function;

FIG. 2 is a diagram describing a problem of the override of the preventive safety function by the autonomous driving function;

FIG. 3 is a block diagram showing a configuration of a control system of an autonomous driving vehicle according to an embodiment of the present disclosure;

FIG. 4 is a block diagram showing functions of an autonomous driving system and a vehicle control system according to the embodiment of the present disclosure;

FIG. 5 is a flowchart showing a flow of a determination of execution/stop of intervention in autonomous driving by the vehicle control system according to the embodiment of the present disclosure;

FIG. 6 is a sequence diagram describing a first diagnostic method of the autonomous driving system;

FIG. 7 is a sequence diagram describing a second diagnostic method of the autonomous driving system;

FIG. 8 is a sequence diagram describing a third diagnostic method of the autonomous driving system;

FIG. 9 is a sequence diagram describing a fourth diagnostic method of the autonomous driving system;

FIG. 10A is a diagram describing an evaluation method of the autonomous driving according to the fourth diagnostic method of the autonomous driving system; and

FIG. 10B is a diagram describing the evaluation method of the autonomous driving according to the fourth diagnostic method of the autonomous driving system.

### DETAILED DESCRIPTION OF EMBODIMENTS

Hereinafter, an embodiment of the present disclosure will be described with reference to the drawings. Where, in a case where the number, a quantity, an amount, a range and the like of each element is described to in the following embodiment, the present disclosure is not limited to the described number except for a case of being particularly specified or a case of being clearly specified in principle by the described number. In addition, a structure, a step, and the like described in the embodiment described below are not always needed in the present disclosure, except for a case of being particularly specified or a case of being clearly specified in principle.

### 1. Outline of Autonomous Driving Vehicle According to Present Embodiment

### 1-1. Autonomous Driving Function and Preventive Safety Function

An autonomous driving vehicle according to the present embodiment is a vehicle having an autonomous driving function of causing the vehicle to be autonomously driven to follow a target trajectory and a preventive safety function of avoiding danger to the vehicle.

The autonomous driving is performed based on needed information for traveling including map information and information related to a surrounding environment of own vehicle. Specifically, an optimum route to a destination is decided based on the map information. Then, a travel plan is created to cause the vehicle to comply with traffic rules and travel safely along the optimum route. The travel plan includes an operation, such as maintaining a traffic lane on which the vehicle currently travels and changing the traffic lane.

In the autonomous driving, the target trajectory is generated based on the travel plan. The target trajectory is a travel trajectory that the vehicle finally adopts, and is decided in consideration of a collision with all obstacles in front of the vehicle obtained from the information related to the surrounding environment of own vehicle. The target trajectory includes a set of target positions of the vehicle on a road on which the vehicle travels and target speed for each target position. In the autonomous driving, in order to cause the vehicle to follow the target trajectory, a deviation (lateral deviation, yaw angle deviation, speed deviation, and the like) between the vehicle and the target trajectory is calculated, and the control of the steering, the braking, or the driving of the vehicle is performed such that the deviation is decreased.

The preventive safety function is control of the braking, the driving, or the steering of the vehicle, or a combination thereof, the control being performed to avoid the imminent danger to the vehicle. The imminent danger to the vehicle as used in the present specification means a type of danger that can be detected by a sensor and can be avoided by controlling the vehicle. A typical example thereof is a collision with an object including the obstacle. In a case where the imminent danger to the vehicle is predicted during execution of the autonomous driving, the intervention in the autonomous driving by the preventive safety function is performed. Specific examples of the preventive safety function include pre-crash safety (PCS). In the PCS, autonomous braking by a braking actuator is used as a preventive safety method.

### 1-2. Override of Preventive Safety Function by Autonomous Driving Function and Problem Thereof

The preventive safety function is the most major function of ensuring the safety of the vehicle. Accordingly, in principle, the preventive safety function takes precedence over other functions. However, in terms of ensuring the safety of the vehicle, the target trajectory is generated in consideration of the collision with the surrounding object even in the autonomous driving. A safety standard for the preventive safety and a safety standard for the autonomous driving do not always match. Therefore, in a case where the autonomous driving function and the preventive safety function are completely independent, even though the target trajectory is generated such that the collision with the surrounding object does not occur, there is a possibility that the preventive safety function is activated and the travel to follow the target trajectory cannot be realized.

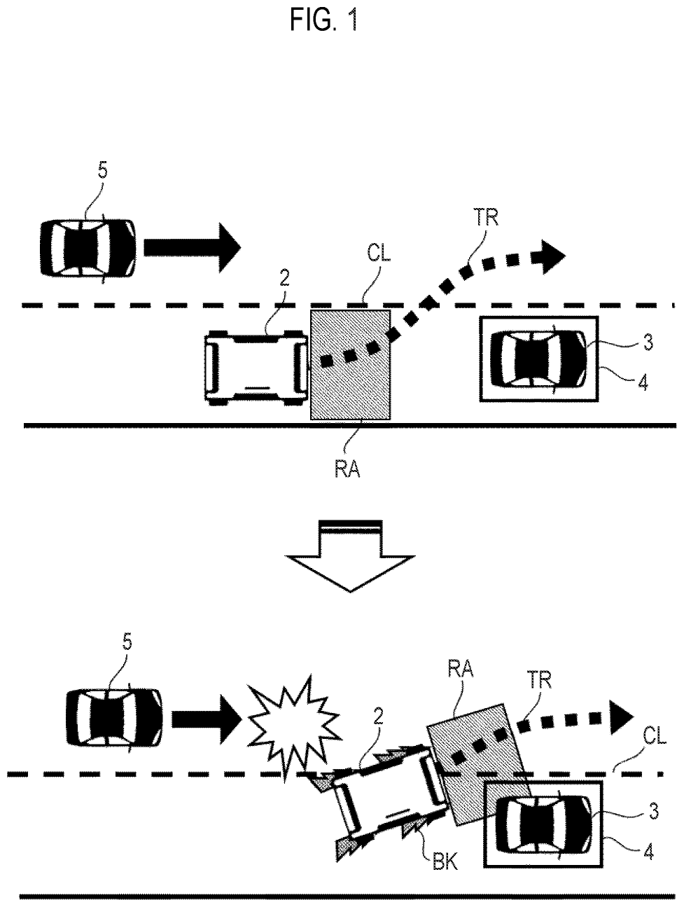

For example, the PCS will be described as an example of the preventive safety function. An upper stage of FIG. 1 shows an example in which an autonomous driving vehicle (hereinafter, also simply referred to as a vehicle) 2 tries to overtake a preceding vehicle 3 beyond a center line CL. In this case, in the autonomous driving function, the preceding vehicle 3 is recognized as a target 4 by a camera, LiDAR, or the like, and a target trajectory TR is generated not to collide with the target 4. Further, in the generation of the target trajectory TR, a relative position and relative speed of a following vehicle 5 with respect to an autonomous driving vehicle 2 are also taken into consideration such that interference with the following vehicle 5 that travels in an adjacent lane does not occur. On the other hand, in the PCS as the preventive safety function, the preceding vehicle 3 is recognized by the camera, a millimeter wave radar, or the like, and a lateral position of the preceding vehicle 3 with respect to the autonomous driving vehicle 2 and time to collision (TTC) of the preceding vehicle 3 with respect to own vehicle are measured. Then, a determination is made as to whether or not the preceding vehicle 3 enters a reaction region RA decided by right and left limit positions of the lateral position and limit time of the TTC.

In a case where the autonomous driving vehicle 2 tries to overtake the preceding vehicle 3 to follow the target trajectory TR, as shown in a lower stage of FIG. 1, there is a possibility that the preceding vehicle 3 enters the reaction region RA depending on a positional relationship between the target trajectory TR and the preceding vehicle 3. In this case, the preventive safety function performs the intervention in the autonomous driving, and a brake BK is applied to avoid the collision between the autonomous driving vehicle 2 and the preceding vehicle 3. As a result, the travel trajectory of the autonomous driving vehicle 2 deviates from the target trajectory, there is a possibility that the autonomous driving vehicle 2 and the following vehicle 5 come into contact with each other by the autonomous driving vehicle 2 decelerating suddenly in a state of straddling the center line CL, as well as the autonomous driving vehicle 2 cannot overtake the preceding vehicle 3.

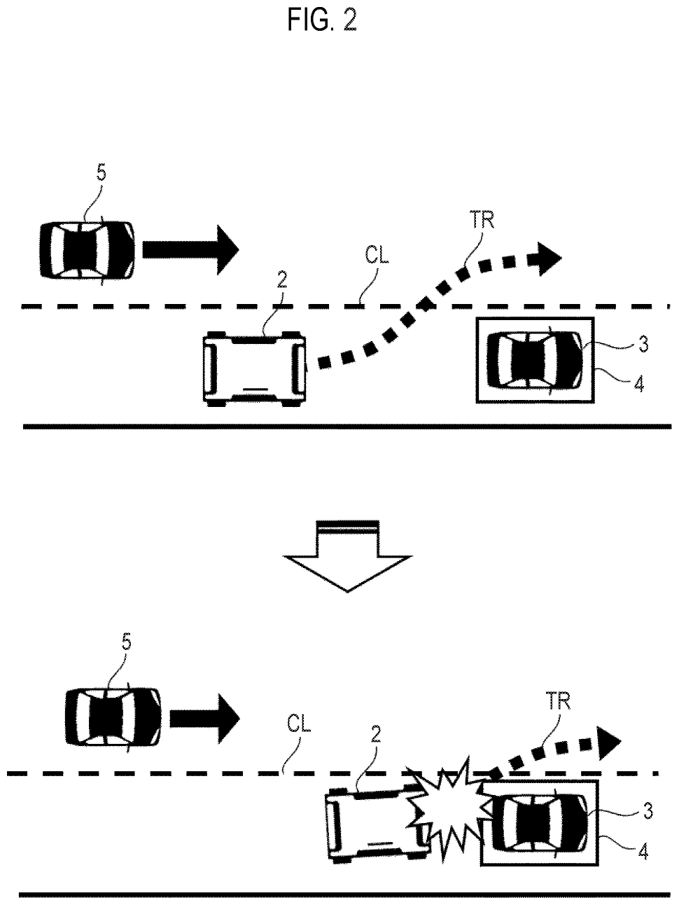

In order to suppress such a situation and to cause the autonomous driving vehicle 2 to travel to follow the target trajectory TR, the override of the preventive safety function by the autonomous driving function is recognized. The override is a function of rejecting the intervention in the autonomous driving by the preventive safety function in a situation in which the preventive safety function is predicted to be activated. In an example shown in an upper stage of FIG. 2, in a case where the target trajectory TR for overtaking the preceding vehicle 3 is generated, the autonomous driving function requests override with respect to the preventive safety function. When this request is received in the preventive safety function, the intervention by the preventive safety function is temporarily stopped. As a result, the autonomous driving vehicle 2 can overtake the preceding vehicle 3 to follow the target trajectory TR without being disturbed by the intervention by the preventive safety function.

However, there is no guarantee that the autonomous driving function always functions normally. In a case where the autonomous driving function does not function normally, there is a possibility that the autonomous driving vehicle 2 cannot be caused to travel to follow the target trajectory TR or the generated target trajectory TR interferes with the preceding vehicle 3. In such a case, it is not desirable to permit the override for the autonomous driving function from the viewpoint of the preventive safety. In a case where the override is permitted even though the autonomous driving function is abnormal, for example, when the target trajectory TR interferes with the preceding vehicle 3 as shown in a lower stage of FIG. 2, there is a possibility that the danger of the collision with the preceding vehicle 3 is increased due to the preventive safety function being not activated.

As described above, when the override of the preventive safety function by the autonomous driving function is always permitted, there is a possibility that the danger to be avoided cannot be avoided depending on a state of the autonomous driving function. The autonomous driving vehicle 2 according to the present embodiment has a configuration for surely avoiding the danger to be avoided and suppressing the not needed intervention in the autonomous driving in a situation in which the realization of the target trajectory is requested. Next, the configuration of the autonomous driving vehicle 2 according to the present embodiment will be described below.

### 2. Configuration of Autonomous Driving Vehicle According to Present Embodiment

### 2-1. Configuration of Control System of Autonomous Driving Vehicle

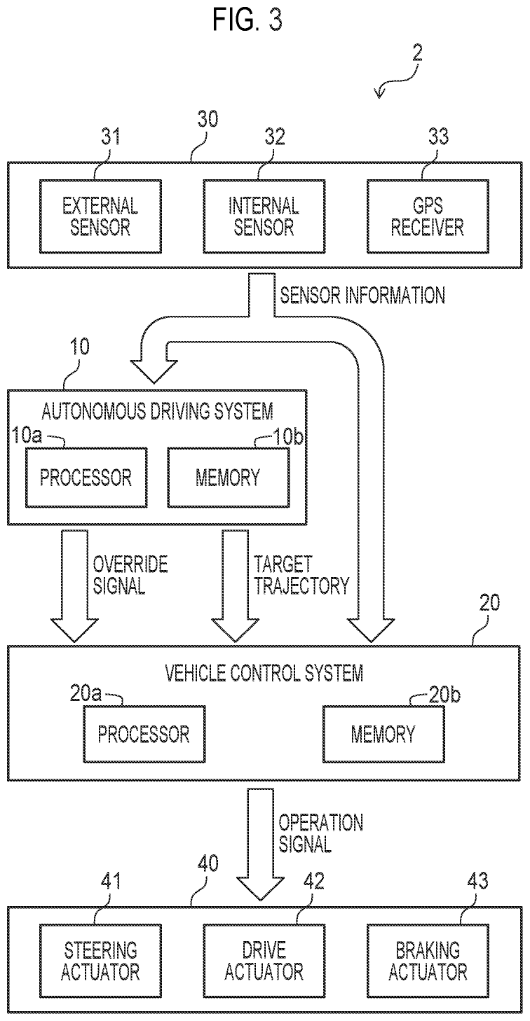

FIG. 3 is a block diagram showing a configuration of a control system of the autonomous driving vehicle 2 according to the present embodiment. The autonomous driving vehicle 2 includes an autonomous driving system 10, a vehicle control system 20, an in-vehicle sensor 30 that inputs sensor information to the autonomous driving system 10 and the vehicle control system 20, and a vehicle actuator 40 that is operated by a signal output from the vehicle control system 20. These components are connected by an in-vehicle network.

The in-vehicle sensor 30 includes an external sensor 31, an internal sensor 32, and a GPS receiver 33. The external sensor 31 is a sensor that acquires the information related to the surrounding environment of the autonomous driving vehicle 2. The external sensor 31 includes the camera, the millimeter wave radar, and the LiDAR. Based on information obtained by the external sensor 31, a process is performed, such as detection of the object present in the periphery of the autonomous driving vehicle 2, measurement of the relative position or the relative speed of the detected object with respect to the autonomous driving vehicle 2, and recognition of a shape of the detected object. The internal sensor 32 is a sensor that acquires information related to the movement of the autonomous driving vehicle 2. The internal sensor 32 includes a wheel speed sensor, an acceleration sensor, a yaw rate sensor, and a steering angle sensor, for example. The GPS receiver 33 is used to acquire information related to a current position of the autonomous driving vehicle 2. In addition to the above, the autonomous driving vehicle 2 also includes a receiver that receives information from the vehicle information and communication system.

The vehicle actuator 40 includes a steering actuator 41 that steers the autonomous driving vehicle 2, a drive actuator 42 that drives the autonomous driving vehicle 2, and a braking actuator 43 that brakes the autonomous driving vehicle 2. The steering actuator 41 includes a power steering system, a steer-by-wire steering system, and a rear wheel steering system, for example. The drive actuator 42 includes an engine, an EV system, and a hybrid system, for example. The braking actuator 43 includes a hydraulic brake and a power regenerative brake, for example.

The autonomous driving system 10 and the vehicle control system 20 are independent electronic control units (ECUs). The autonomous driving system 10 and the vehicle control system 20 include processors 10a, 20a and memories 10b, 20b, respectively. In some embodiments, the processors 10a, 20a are multi-core processors. Various programs or various pieces of data are stored in the memories 10b, 20b. The memories 10b, 20b described herein include a main storage device and an auxiliary storage device. Input and output of the needed information are performed between the autonomous driving system 10 and the vehicle control system 20 via, for example, CAN communication.

Although the details will be described below, the autonomous driving system 10 is a system that manages the autonomous driving of the autonomous driving vehicle 2. The memory 10b provided in the autonomous driving system 10 stores a program for the autonomous driving that can be executed by the processor 10a and various pieces of information related thereto. The information includes the map information. By executing the autonomous driving program by the processor 10a, the autonomous driving function functions in the autonomous driving system 10. The autonomous driving system 10 generates the target trajectory for the autonomous driving, and inputs the generated target trajectory to the vehicle control system 20. Further, in a case where the autonomous driving system 10 rejects the intervention in the autonomous driving of the preventive safety function, the autonomous driving system 10 inputs an override signal to the vehicle control system 20.

Although the details will be described below, the vehicle control system 20 is a system responsible for managing the movement of the autonomous driving vehicle 2. The vehicle control system 20 operates the vehicle actuator 40 such that the autonomous driving vehicle 2 follows the target trajectory input from the autonomous driving system 10. The memory 20b provided in the vehicle control system 20 stores a program that can be executed by the processor 20a and various pieces of information related thereto. The program includes a preventive safety program. By executing the preventive safety program by the processor 20a, the vehicle control system 20 functions as a preventive safety system. In a case where the autonomous driving vehicle 2 is predicted to have the imminent danger, the vehicle control system 20 as the preventive safety system performs the intervention in the autonomous driving to operate the autonomous driving vehicle 2 to avoid the danger. Where, in a case where the override signal is input from the autonomous driving system 10, the vehicle control system 20 stops the intervention by the preventive safety function solely in a case where a predetermined intervention stop condition is satisfied.

### 2-2. Functions of Autonomous Driving System and Vehicle Control System

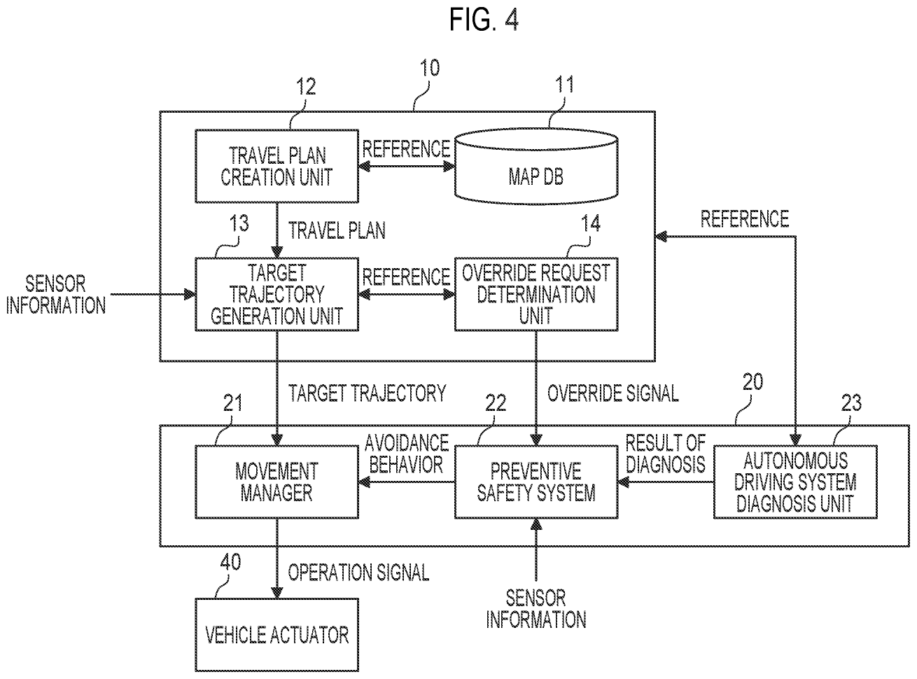

FIG. 4 is a block diagram showing functions of the autonomous driving system 10 and the vehicle control system 20 according to the present embodiment. Next, details of each function of the autonomous driving system 10 and the vehicle control system 20 will be described below with reference to FIG. 4.

The autonomous driving system 10 includes a map database (map DB) 11, a travel plan creation unit 12, a target trajectory generation unit 13, and an override request determination unit 14. These components are realized as functions of the autonomous driving system 10 when the program stored in the memory 10b is executed by the processor 10a. The map information described above is managed by the map DB 11. The map DB 11 is stored in advance in the auxiliary storage device, such as an SSD or an HDD. Where, the map information may be downloaded from an external server via the Internet, or the map information in the external server may be referred to.

The travel plan creation unit 12 acquires the optimum route to the destination from the map DB 11, and creates the travel plan to cause the autonomous driving vehicle 2 to comply with the traffic rules and travel safely along the optimum route. The travel plan includes a travel route of the vehicle and an operation of the autonomous driving vehicle 2, such as maintaining a traffic lane on which the vehicle currently travels and changing the traffic lane.

The target trajectory generation unit 13 generates the target trajectory based on the travel plan. The target trajectory is a travel trajectory that the autonomous driving vehicle 2 finally adopts, and the target trajectory generation unit 13 decides the target trajectory in consideration of the collisions with all obstacles in front of the autonomous driving vehicle 2. The target trajectory generation unit 13 acquires the surrounding information of the autonomous driving vehicle 2 by using, for example, the LiDAR, the camera, a fusion of the LiDAR and the camera, or a fusion of the LiDAR, the camera, and the millimeter wave radar, and generates the target trajectory based on the acquired information. The target trajectory generation unit 13 generates the target trajectory having a plurality of sets of two elements of a target position p in a coordinate system fixed to the autonomous driving vehicle 2 and speed v (alternately, acceleration) at each target point, that is, configuration coordinates (p, v). Here, each target position p has at least an x-coordinate position and a y-coordinate position in the coordinate system fixed to the vehicle or information equivalent thereto. The target trajectory generation unit 13 inputs the generated target trajectory to the vehicle control system 20.

The override request determination unit 14 determines whether or not to request the override of the preventive safety function with respect to the vehicle control system 20. In the override request determination unit 14, a situation in which the operation of the autonomous driving vehicle 2 by the autonomous driving can activate the preventive safety function is registered in advance. For example, as described above, a scene in which the vehicle overtakes the preceding vehicle that travels is one of the situations in which the preventive safety function can be activated. In addition, examples of the situation in which the preventive safety function can be activated include a scene in which the vehicle passes through a side of a stopped vehicle or a falling object or a scene in which changing of the traffic lane is performed. The override request determination unit 14 determines whether or not the preventive safety function can be activated from the target trajectory generated by the target trajectory generation unit 13, and inputs the override signal to the vehicle control system 20 in a case where the preventive safety function can be activated.

The vehicle control system 20 includes a movement manager 21, a preventive safety system 22, and an autonomous driving system diagnosis unit 23. These components are realized as functions of the vehicle control system 20 when the program stored in the memory 20b is executed by the processor 20a. Where, in a case where the vehicle control system 20 is configured by a plurality of the ECUs, a function of the movement manager 21 and a function of the preventive safety system 22 (and autonomous driving system diagnosis unit 23) may be assigned to the separate ECUs.

The movement manager 21 performs a follow control of causing the autonomous driving vehicle 2 to follow the target trajectory. In the follow control, based on a deviation between actual acceleration calculated from a speed sensor and target acceleration in the target trajectory, braking/driving force for matching the actual acceleration and the target acceleration is calculated. The calculated braking/driving force is distributed to requested braking force requested for the braking actuator 43 and requested driving force requested for the drive actuator 42. Further, in the follow control, a steering angle for matching the actual travel trajectory of the vehicle with the target trajectory is calculated as a requested steering angle requested for the steering actuator 41. The movement manager 21 converts the requested braking force, the requested driving force, and the requested steering angle for causing the autonomous driving vehicle 2 to follow the target trajectory into operation signals, respectively, and inputs the converted signals to the corresponding vehicle actuator 40. Where, in a case where the preventive safety system 22 described below receives an instruction for an avoidance action, the movement manager 21 gives priority to the instruction from the preventive safety system 22.

The preventive safety system 22 detects the obstacle in front of the autonomous driving vehicle 2 based on the sensor information from the external sensor 31. The sensor information used in the preventive safety system 22 may be common to or different from the sensor information used in the target trajectory generation unit 13. For example, the detection of the obstacle may be performed by using the camera and the millimeter wave radar. In a case where the obstacle is detected in front of the autonomous driving vehicle 2, the preventive safety system 22 determines dangerousness of the collision between the autonomous driving vehicle 2 and the obstacle. Specifically, the preventive safety system 22 calculates the TTC from a relative distance from the autonomous driving vehicle 2 to the detected obstacle and the relative speed. Then, in a case where the TTC is equal to or less than a threshold value and a lateral position of the obstacle with respect to the autonomous driving vehicle 2 overlaps with the autonomous driving vehicle 2, the preventive safety system 22 determines that the autonomous driving vehicle 2 has high dangerousness of the collision with the detected obstacle. In a situation in which a determination is made that the dangerousness of the collision is high, the preventive safety system 22 provides an instruction with respect to the movement manager 21 such that the avoidance action for avoiding the danger is adopted, except for a case the predetermined intervention stop condition is satisfied. That is, the preventive safety system 22 performs the intervention in the autonomous driving. The content of the avoidance action instructed with respect to the movement manager 21 is typically emergency braking by the braking actuator 43, limitation of the driving force by the drive actuator 42, avoidance steering by the steering actuator 41, or a combination thereof.

The autonomous driving system diagnosis unit 23 performs a diagnosis as to whether the autonomous driving system 10 is normal or abnormal. The intervention stop condition described above is that the override signal is input from the autonomous driving system 10 to the preventive safety system 22 and the autonomous driving system 10 is normal. A result of the diagnosis of the autonomous driving system 10 is input from the autonomous driving system diagnosis unit 23 to the preventive safety system 22. A diagnostic method by the autonomous driving system 10 will be described below.

### 2-3. Flow of Determination of Execution/Stop of Intervention in Autonomous Driving

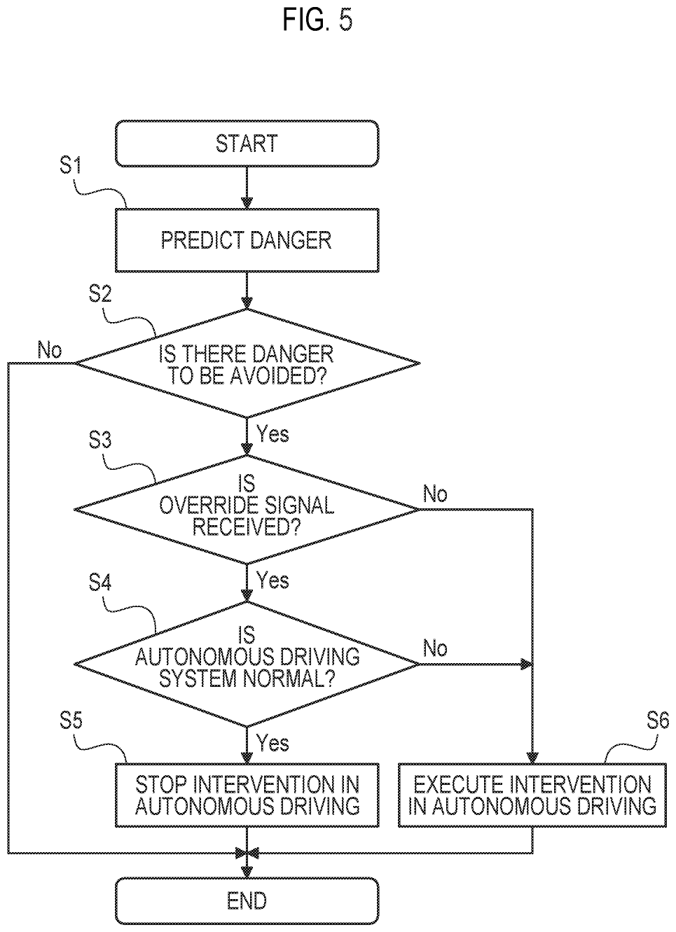

As described above, in the present embodiment, in a case where the danger is predicted, the vehicle control system 20 performs the intervention in the autonomous driving, but in a case where the predetermined intervention stop condition is satisfied, the intervention in the autonomous driving is stopped. FIG. 5 is a flowchart showing a flow of determination of execution/stop of the intervention in the autonomous driving by the vehicle control system 20. Note that a vehicle control method according to the present embodiment is also shown in FIG. 5.

First, the vehicle control system 20 predicts the danger based on the sensor information related to the surrounding environment of the autonomous driving vehicle 2 obtained by the external sensor 31 (step S1). Then, based on a result of the prediction in step S1, the vehicle control system 20 determines the presence or absence of the danger to be avoided by the autonomous driving vehicle 2 (step S2). When there is no danger to be avoided, the intervention in the autonomous driving is not performed in the first place, and thus the remaining processes is skipped.

In a case where there is the danger to be avoided, the vehicle control system 20 determines whether or not the override signal is received from the autonomous driving system 10 (step S3). When the override signal is not received, the autonomous driving system 10 does not reject the intervention by the preventive safety function. Therefore, in this case, the vehicle control system 20 executes the intervention in the autonomous driving by the preventive safety function (step S6).

In a case where the override signal is received, the vehicle control system 20 determines whether the autonomous driving system 10 is normal or abnormal by the diagnostic method described below (step S4). In a case where the autonomous driving system 10 is abnormal, for example, in a case where the generated target trajectory interferes with the obstacle, even when the autonomous driving system 10 requests the override, the request for the override cannot be permitted. Therefore, in a case where the autonomous driving system 10 is abnormal, the vehicle control system 20 rejects the request for the override from the autonomous driving system 10 and executes the intervention in the autonomous driving by the preventive safety function (step S6).

Note that the autonomous driving system 10 in which the abnormality occurs cannot be allowed to continue the driving as it is. Therefore, in a case where a determination is made that the autonomous driving system 10 is abnormal in the determination of step S4, the vehicle control system 20 performs the intervention in the autonomous driving to perform the emergency stop of the autonomous driving vehicle 2 or to move the autonomous driving vehicle 2 to a place in which the safety can be ensured and stop the autonomous driving vehicle 2 at the place.

In a case where the autonomous driving system 10 requests the override and the autonomous driving system 10 is normal, the vehicle control system 20 stops the intervention in the autonomous driving by the preventive safety function (step S5). As described above, in a case where the autonomous driving system 10 is normal, the vehicle control system 20 stops the intervention in the autonomous driving when the autonomous driving system 10 rejects the intervention. However, in a case where the autonomous driving system 10 is abnormal, the vehicle control system 20 executes the intervention in the autonomous driving even when the autonomous driving system 10 rejects the intervention. As a result, the danger to be avoided can be surely avoided and the not needed intervention in the autonomous driving in a situation in which the realization of the target trajectory is requested can be suppressed.

### 2-4. Diagnostic Method of Autonomous Driving System 2-4-1. First Diagnostic Method

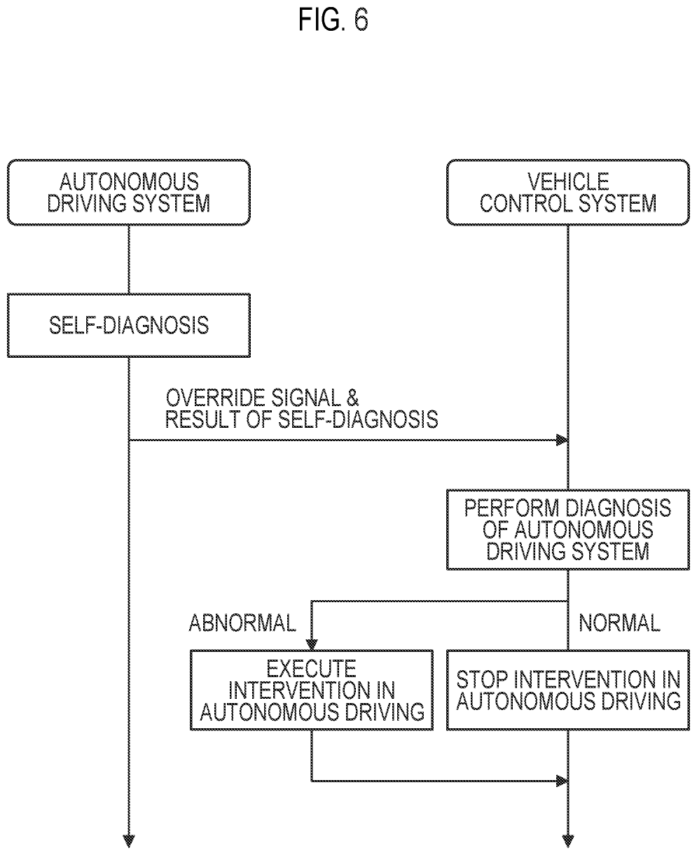

Examples of the diagnostic method of the autonomous driving system 10 include four diagnostic methods of a first diagnostic method to a fourth diagnostic method. First, the first diagnostic method of the autonomous driving system 10 will be described with reference to FIG. 6. FIG. 6 is a sequence diagram describing the first diagnostic method of the autonomous driving system 10.

As shown in FIG. 6, in the first diagnostic method, the autonomous driving system 10 performs a self-diagnosis. In the self-diagnosis, checking of predetermined items related to the autonomous driving is performed. In a case where the override signal is transmitted to the vehicle control system 20, the autonomous driving system 10 transmits a result of the self-diagnosis together with the override signal. The vehicle control system 20 receives the result of the self-diagnosis from the autonomous driving system 10 and performs the diagnosis as to whether the autonomous driving system 10 is normal or abnormal based on the result of the self-diagnosis. Accordingly, when the result of the self-diagnosis declared by the autonomous driving system 10 is normal, the diagnosis can be made that the autonomous driving system 10 is normal, and when the result of the self-diagnosis declared is abnormal, the diagnosis can be made that the autonomous driving system 10 is abnormal.

Note that in the sequence diagram, the autonomous driving system 10 transmits the override signal and the result of the self-diagnosis at the same time, but may transmit the result of the self-diagnosis first. In a case where the result of the self-diagnosis transmitted first is normal, the vehicle control system 20 confirms the result of the self-diagnosis again after the override signal is received. Then, when the result of the self-diagnosis confirmed again remains normal, the vehicle control system 20 stops the intervention in the autonomous driving, but when the result of the self-diagnosis is changed to abnormal, the vehicle control system 20 executes the intervention in the autonomous driving.

### 2-4-2. Second Diagnostic Method

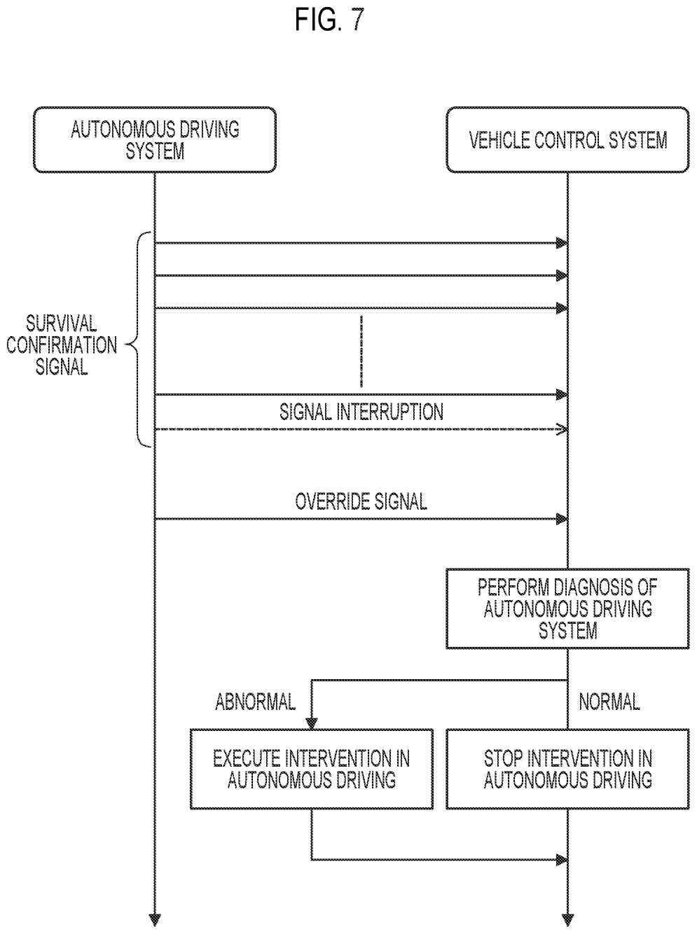

Next, the second diagnostic method of the autonomous driving system 10 will be described with reference to FIG. 7. FIG. 7 is a sequence diagram describing the second diagnostic method of the autonomous driving system 10.

As shown in FIG. 7, in the second diagnostic method, the autonomous driving system 10 periodically transmits a survival confirmation signal to the vehicle control system 20. A dedicated channel for transmitting and receiving the survival confirmation signal may be provided between the vehicle control system 20 and the autonomous driving system 10. The vehicle control system 20 receives the survival confirmation signal periodically transmitted from the autonomous driving system 10, and performs the diagnosis as to whether the autonomous driving system 10 is normal or abnormal based on the survival confirmation signal. Specifically, while the survival confirmation signal is periodically transmitted from the autonomous driving system 10, the diagnosis can be made that the autonomous driving system 10 is normal, and in a case where the survival confirmation signal is interrupted, the diagnosis can be made that the autonomous driving system 10 is abnormal. In an example shown in FIG. 7, the survival confirmation signal is interrupted before the override signal is received. Therefore, in this example, the vehicle control system 20 performs the diagnosis that the autonomous driving system 10 is abnormal, and executes the intervention in the autonomous driving.

Note that in the example shown in FIG. 7, the determination is made as to whether the autonomous driving system 10 is normal or abnormal based on the interruption of the survival confirmation signal before the override signal is received, but the diagnosis can be made based on the survival confirmation signal after the override signal is received. In this case, after the override signal is received, the vehicle control system 20 starts the intervention in the autonomous driving or prepares to start the intervention. When the survival confirmation signal cannot be confirmed after the override signal is received, the vehicle control system 20 continues the intervention in the autonomous driving, and when the survival confirmation signal is confirmed, the vehicle control system 20 stops the intervention in the autonomous driving.

### 2-4-3. Third Diagnostic Method

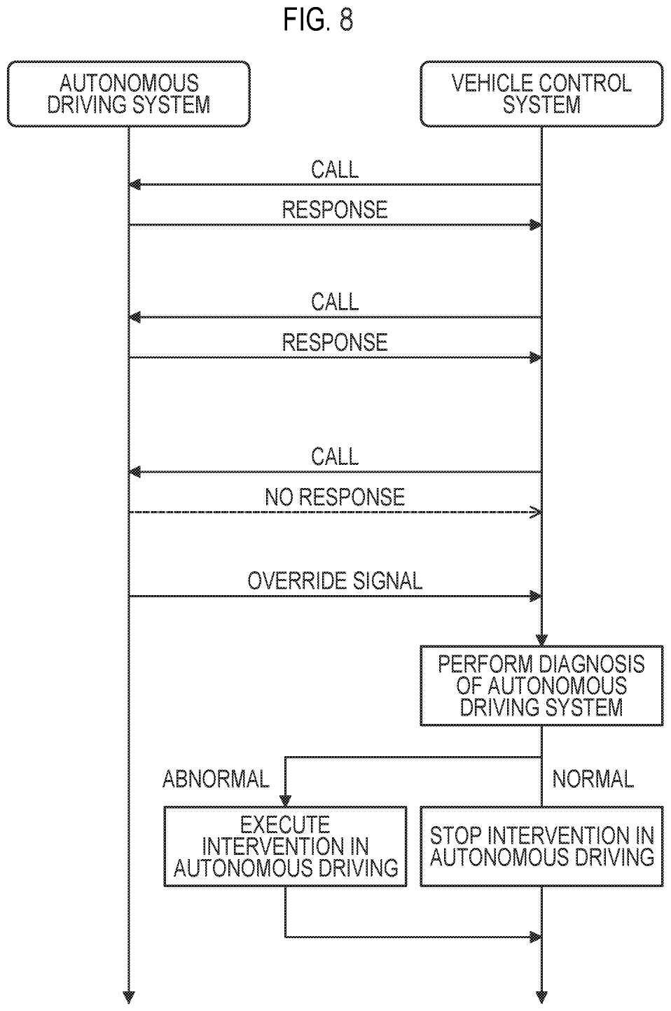

Next, the third diagnostic method of the autonomous driving system 10 will be described with reference to FIG. 8. FIG. 8 is a sequence diagram describing the third diagnostic method of the autonomous driving system 10.

As shown in FIG. 8, in the third diagnostic method, the vehicle control system 20 repeatedly performs the call with respect to the autonomous driving system 10, and the autonomous driving system 10 responds to the call each time. The call from the vehicle control system 20 may be regular or irregular. Further, a dedicated channel for exchanging the call and a response signal may be provided between the vehicle control system 20 and the autonomous driving system 10. The vehicle control system 20 performs the diagnosis as to whether the autonomous driving system 10 is normal or abnormal based on the response from the autonomous driving system 10 to the call. Specifically, while the autonomous driving system 10 responds to the call from the vehicle control system 20, the diagnosis can be made that the autonomous driving system 10 is normal, and in a case where the autonomous driving system 10 does not respond to the call, the diagnosis can be made that the autonomous driving system 10 is abnormal. In an example shown in FIG. 8, the response from the vehicle control system 20 to the call is not present before the override signal is received. Therefore, in this example, the vehicle control system 20 performs the diagnosis that the autonomous driving system 10 is abnormal, and executes the intervention in the autonomous driving.

Note that unlike the example shown in FIG. 8, the vehicle control system 20 can perform the call with respect to the autonomous driving system 10 after the override signal is received, and can perform the diagnosis as to whether the autonomous driving system is normal or abnormal based on the presence or absence of the response to the call. In this case, after the override signal is received, the vehicle control system 20 starts the intervention in the autonomous driving or prepares to start the intervention. Thereafter, when the autonomous driving system 10 does not respond to the call after the override signal is received, the vehicle control system 20 continues the intervention in the autonomous driving, and when the autonomous driving system 10 responds to the call, the vehicle control system 20 stops the intervention in the autonomous driving.

### 2-4-4. Fourth Diagnostic Method

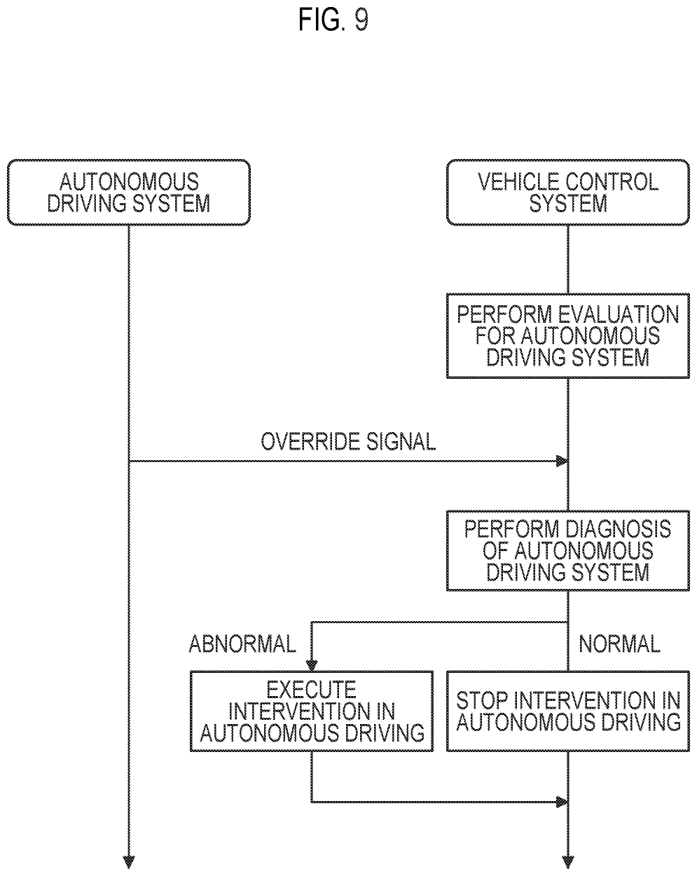

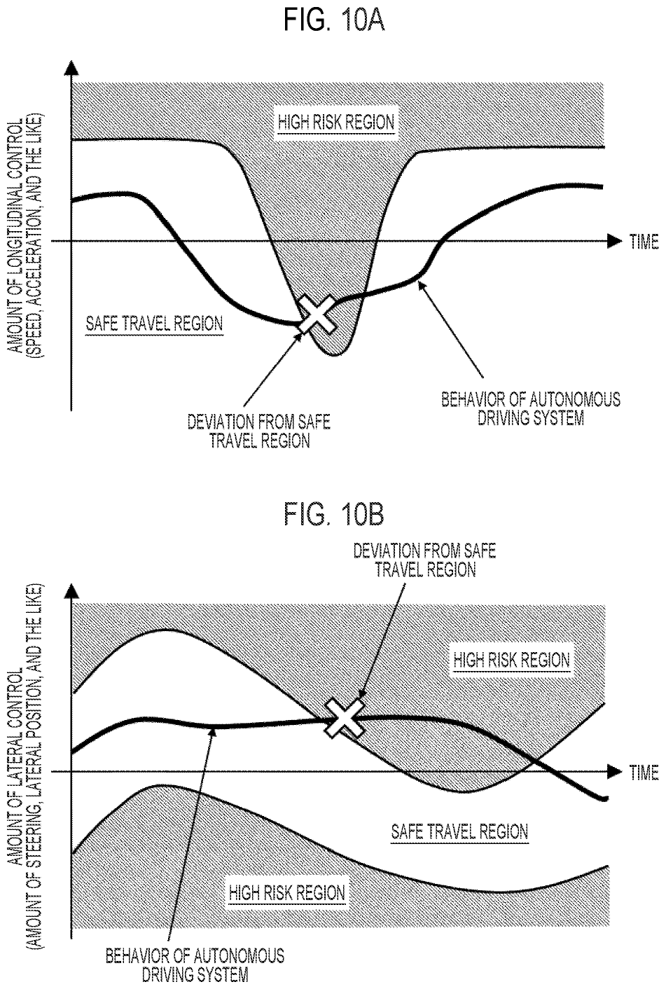

Next, the fourth diagnostic method of the autonomous driving system 10 will be described with reference to FIGS. 9, 10A, and 10B. FIG. 9 is a sequence diagram describing the fourth diagnostic method of the autonomous driving system 10. FIGS. 10A and 10B are diagrams describing the evaluation methods of the autonomous driving according to the fourth diagnostic method of the autonomous driving system 10.

As shown in FIG. 9, in the fourth diagnostic method, the vehicle control system 20 performs evaluation for the autonomous driving performed by the autonomous driving system 10. Then, based on a result of the evaluation, the vehicle control system 20 performs the diagnosis as to whether the autonomous driving system 10 is normal or abnormal. Since whether the autonomous driving system 10 is normal or abnormal appears in a result of the autonomous driving, the diagnosis can be made as to whether the autonomous driving system 10 is normal or abnormal by performing the evaluation for the autonomous driving.

The evaluation for the autonomous driving can be performed based on, for example, an amount of a longitudinal control and an amount of a lateral control of the autonomous driving vehicle 2 realized by the autonomous driving system 10 as shown in FIGS. 10A and 10B. The amount of the longitudinal control includes, for example, speed and acceleration, and the amount of the lateral control includes, for example, an amount of steering and the lateral position. FIG. 10A shows a safe travel region and a high risk region of the amount of the longitudinal control assumed by the vehicle control system 20. FIG. 10B shows a safe travel region and a high risk region of the amount of the lateral control assumed by the vehicle control system 20. As shown in FIGS. 10A and 10B, in a case where a behavior of the autonomous driving vehicle 2 by the autonomous driving system 10 exceeds the safe travel region, an estimation can be made that the autonomous driving system 10 is in a state where an accident risk cannot be sufficiently considered.

In an example shown in FIG. 9, the evaluation for the autonomous driving is performed before the override signal is received, but the evaluation for the autonomous driving can be performed after the override signal is received. In this case, after the override signal is received, the vehicle control system 20 starts the intervention in the autonomous driving or prepares to start the intervention. Thereafter, the evaluation for the autonomous driving is performed, and when a confirmation cannot be made that the autonomous driving system 10 is normal from the result of the evaluation, the vehicle control system 20 continues the intervention in the autonomous driving, and when a confirmation can be made that the autonomous driving system 10 is normal, the vehicle control system 20 stops the intervention in the autonomous driving.

### 3. Other Embodiments

In the embodiment described above, the autonomous driving system 10 transmits the override signal to the vehicle control system 20 in a case where the intervention in the autonomous driving by the vehicle control system 20 is estimated and the estimated intervention in the autonomous driving is not needed. In this case, a case is needed to be assumed in advance where the vehicle control system 20 performs the intervention in the autonomous driving. Therefore, in the autonomous driving vehicle according to the embodiment of the present disclosure, in a case where the vehicle control system 20 performs the intervention in the autonomous driving, the autonomous driving system 10 may be previously notified of the intervention in the autonomous driving. Then, the autonomous driving system 10 may transmit the override signal to the vehicle control system 20 in a case where the previously notified intervention in the autonomous driving is not needed. Accordingly, in a case where the autonomous driving system 10 is normal, before the intervention in the autonomous driving previously notified by the vehicle control system 20 is performed, the override signal can be transmitted to the vehicle control system 20 and the intervention in the autonomous driving can be stopped.

What is claimed is:

1. A vehicle control system that is mounted on a vehicle that performs autonomous driving, predicts danger based on information related to a surrounding environment of the vehicle, and performs intervention in the autonomous driving to avoid the predicted danger, the vehicle control system comprising:
at least one memory including at least one program; and
at least one processor coupled to the at least one memory,
wherein the at least one processor is configured to execute, by execution of the at least one program,
generating a target trajectory of the vehicle and perform communication with an autonomous driving system that causes the vehicle to travel by the autonomous driving to follow the target trajectory,
receiving an override signal for rejecting the intervention in the autonomous driving from the autonomous driving system,
performing a diagnosis as to whether the autonomous driving system is normal or abnormal, and
stopping the intervention in the autonomous driving solely in a case where the override signal is received and the autonomous driving system is normal.

2. The vehicle control system according to claim 1, wherein the at least one processor is configured to receive a result of a self-diagnosis from the autonomous driving system and perform the diagnosis based on the result of the self-diagnosis.

3. The vehicle control system according to claim 1, wherein the at least one processor is configured to receive a survival confirmation signal periodically transmitted from the autonomous driving system and perform the diagnosis based on the survival confirmation signal.

4. The vehicle control system according to claim 1, wherein the at least one processor is configured to irregularly or regularly perform a call with respect to the autonomous driving system and perform the diagnosis based on a response to the call.

5. The vehicle control system according to claim 1, wherein the at least one processor is configured to perform evaluation for the autonomous driving performed by the autonomous driving system and perform the diagnosis based on a result of the evaluation.

6. An autonomous driving vehicle comprising:
an autonomous driving system that generates a target trajectory and performs autonomous driving to follow the target trajectory; and
a vehicle control system that predicts danger based on information related to a surrounding environment and performs intervention in the autonomous driving to avoid the predicted danger, wherein:
the autonomous driving system executes transmitting an override signal for rejecting the intervention in the autonomous driving to the vehicle control system in a case where the intervention in the autonomous driving by the vehicle control system is not needed; and
the vehicle control system executes
receiving the override signal from the autonomous driving system,
performing a diagnosis as to whether the autonomous driving system is normal or abnormal, and
stopping the intervention in the autonomous driving solely in a case where the override signal is received and the autonomous driving system is normal.

7. The autonomous driving vehicle according to claim 6, wherein the autonomous driving system transmits the override signal to the vehicle control system in a case where the intervention in the autonomous driving by the vehicle control system is estimated and the estimated intervention in the autonomous driving is not needed.

8. The autonomous driving vehicle according to claim 6, wherein:
the vehicle control system previously notifies the autonomous driving system of the intervention in the autonomous driving in a case where the vehicle control system performs the intervention in the autonomous driving; and
the autonomous driving system transmits the override signal to the vehicle control system in a case where the previously notified intervention in the autonomous driving is not needed.

9. The autonomous driving vehicle according to claim 6, wherein:
the autonomous driving system performs a self-diagnosis as to whether the autonomous driving system itself is normal or abnormal and transmits a result of the self-diagnosis to the vehicle control system; and
the vehicle control system receives the result of the self-diagnosis from the autonomous driving system and performs the diagnosis based on the result of the self-diagnosis.

10. The autonomous driving vehicle according to claim 6, wherein:
the autonomous driving system periodically transmits a survival confirmation signal to the vehicle control system; and
the vehicle control system receives the survival confirmation signal from the autonomous driving system and performs the diagnosis based on the survival confirmation signal.

11. The autonomous driving vehicle according to claim 6, wherein:
the autonomous driving system responds to an irregular or regular call from the vehicle control system; and
the vehicle control system performs the diagnosis based on the response from the autonomous driving system.

12. The autonomous driving vehicle according to claim 6, wherein the vehicle control system performs evaluation for the autonomous driving performed by the autonomous driving system and performs the diagnosis based on a result of the evaluation.

13. A vehicle control method of controlling a vehicle that is autonomously driven to follow a target trajectory by an autonomous driving system, the vehicle control method comprising:
predicting danger to be avoided by the vehicle based on information related to a surrounding environment of the vehicle;
in a case where the danger is predicted,
determining whether or not the autonomous driving system rejects intervention in the autonomous driving;
performing a diagnosis as to whether the autonomous driving system is normal or abnormal;
performing the intervention in the autonomous driving to avoid the predicted danger in a case where the autonomous driving system is abnormal or the autonomous driving system does not reject the intervention in the autonomous driving; and
stopping the intervention in the autonomous driving in a case where the autonomous driving system rejects the intervention in the autonomous driving in a state where the autonomous driving system is normal.

14. The vehicle control method according to claim 13, wherein the diagnosis as to whether the autonomous driving system is normal or abnormal is performed based on at least one of a result of a self-diagnosis by the autonomous driving system, a survival confirmation signal periodically transmitted from the autonomous driving system, a response from the autonomous driving system to a call in a case where the call is irregularly or regularly performed with respect to the autonomous driving system, and a result of evaluation for the autonomous driving performed by the autonomous driving system.
